(19) United States
(12) Patent Application Publication
(10) Pub. No.: US 2025/0056205 A1
(43) Pub. Date: Feb. 13, 2025

(54) METHOD PERFORMED BY USER EQUIPMENT, AND USER EQUIPMENT

(71) Applicant: SHARP KABUSHIKI KAISHA, Sakai City, Osaka (JP)

(72) Inventors: FANGYING XIAO, Shanghai (CN); Renmao LIU, Shanghai (CN)

(21) Appl. No.: 18/723,726

(22) PCT Filed: Dec. 28, 2022
(86) PCT No.: PCT/CN2022/142905

§ 371 Date: Jun. 24, 2024

(30) Foreign Application Priority Data
Dec. 31, 2021 (CN) 202111680673.2

(51) Int. Cl. H04W 8/18; H04W 76/38

(52) U.S. Cl. CPC H04W 8/186; H04W 76/38

(57) ABSTRACT

The present invention provides a method performed by user equipment, and user equipment. The method is performed when user equipment (UE) at least having dual Rx/Tx capabilities is configured with both a master cell group (MCG) and a secondary cell group (SCG) by a network, and includes the following steps: the UE including, in a request message, instruction information used to instruct the network to deactivate or release the SCG, the instruction information being used to request the network to deactivate or release the SCG for a multi-universal subscriber identity module (MUSIM) purpose, and the instruction information being included in a UE assistance information message.

### TECHNICAL FIELD

The present invention relates to the technical field of wireless communications, and in particular to a method performed by user equipment, and corresponding user equipment.

### BACKGROUND

In recent years, multi-USIM card devices have become increasingly popular. For example, a user installs two USIM cards on a mobile phone supporting a plurality of USIM cards, and one of the USIM cards is used for subscribing to private services whereas the other USIM card is used for subscribing to office services. Existing devices that support a plurality of USIM cards are implemented on the basis of manufacturers, and have not been standardized by the 3GPP. Therefore, different manufacturers use different implementation means, and behaviors of user equipment (UE) units are likewise different from each other. In existing implementations, if these USIM cards are respectively registered to networks (the USIM cards may be registered to the same network or respectively registered to two or more networks), the UE needs to receive paging from these networks. On the basis of transceiving capabilities of the UE, a possible scenario exists in which, when the UE receives paging of a current network, another network also initiates paging for the UE, or when the UE is communicating with a network, another network initiates paging for the UE. If the UE switches between different networks, a possible result is that the UE can no longer receive data from the current network when the UE switches to another network. This would compromise network performance. For example, the network transmits paging to the UE, but the UE does not receive this paging because the UE has switched to another network, or the UE switches to another network and therefore cannot receive scheduling of the current network. Some manufacturers proposed 3GPP standardization study on network accessing behaviors of UEs having a plurality of USIM cards and related networks, the benefit of which is that network performance can be improved on the basis of predictable UE behavior.

On the basis of the above-described reason, in December 2019, a work item for multi-SIM card devices in Release 17 was proposed by vivo at the 3rd Generation Partnership Project (3GPP) RAN #86 plenary meeting (see Non-Patent Document: RP-193263: New WID: Support of Multi-SIM devices in Rel-17), and was approved. One of the objectives of the work item is to define a mechanism for notifying network A when UE leaves network A, where network A is NR, network B is LTE or NR, and the UE is single-Rx/single-Tx, or the UE is dual-Rx/single-Tx.

At the 3GPP RAN #94bis meeting in December 2021, further enhancements to multi-USIM card UE having dual Rx/Tx capabilities were agreed upon, so that UE can be in an RRC connected state simultaneously in two networks (see Non-Patent Document: RP-213584 New WI on Dual Tx Rx MUSIM enhancements).

The present disclosure discusses relevant problems involved in achieving the above work objectives.

### SUMMARY

In order to address at least part of the aforementioned issues, the present invention provides a method performed by user equipment, and corresponding user equipment.

According to one aspect of the present invention, provided is a method performed by user equipment, the method being performed when user equipment (UE) at least having dual Rx/Tx capabilities is configured with both a master cell group (MCG) and a secondary cell group (SCG) by a network, the method comprising the following steps:
the UE including, in a request message, instruction information used to instruct the network to deactivate or release the SCG, the instruction information being used to request the network to deactivate or release the SCG for a multi-universal subscriber identity module (MUSIM) purpose, and the instruction information being included in a UE assistance information message.

In the above method performed by user equipment, preferably,
in a procedure in which the UE requests, for the MUSIM purpose, the network to deactivate or release the SCG to initiate transmission of the UE assistance information message so as to provide MUSIM assistance information,
if the UE prefers to deactivate or release the SCG, then a first SCG deactivation/release request indicator is comprised in the UE assistance information.

In the above method performed by user equipment, preferably,
in a procedure in which the UE requests, not for the MUSIM purpose, the network to deactivate or release the SCG to initiate transmission of the UE assistance information message so as to provide MUSIM assistance information,
if the UE prefers to deactivate or release the SCG, then a second SCG deactivation/release request indicator different from the first SCG deactivation/release request indicator is comprised in the UE assistance information message so as to request a base station to deactivate or release the SCG.

In the above method performed by user equipment, preferably,
if the UE is configured to provide the MUSIM assistance information, if the UE prefers to deactivate the SCG, and if a timer T1 is not running, then at least one of the following operations is performed:
initiating, by the UE, transmission of the UE assistance information message to provide the MUSIM assistance information; and
starting the timer T1.

In the above method performed by user equipment, preferably,
if the UE is configured to provide the MUSIM assistance information, if the UE prefers to release the SCG, and if a timer T2 is not running, then at least one of the following operations is performed:
initiating, by the UE, transmission of the UE assistance information message to provide the MUSIM assistance information; and
starting the timer T2.

In the above method performed by user equipment, preferably,
the timer T1 and the timer T2 are the same timer.

In the above method performed by user equipment, preferably,
if the UE is configured to provide the MUSIM assistance information, and if the SCG state preferred by the UE changes, then the following operation is performed:
initiating, by the UE, transmission of the UE assistance information message to provide the MUSIM assistance information.

In the above method performed by user equipment, preferably,
only when the UE is not in an RRC connected state in another network and uplink data for an SCG radio bearer arrives at the UE, does the UE use the UE assistance information message to request a base station to activate the SCG or indicate to the base station that uplink data for an SCG radio bearer has arrived.

In the above method performed by user equipment, preferably,
when the UE receives a UE capability query message from a base station,
if the UE supports activation or deactivation or release of the SCG for the MUSIM purpose, then MUSIM SCG-related capability information thereof is reported.

According to another aspect of the present invention, user equipment is provided, comprising:
a processor; and
a memory having instructions stored therein,
the instructions, when run by the processor, causing the user equipment to perform the method described above.

### Beneficial Effects of Present Invention

According to the method performed by user equipment and corresponding user equipment to which the present invention relates, user equipment at least having dual Rx/Tx capabilities is enabled to effectively request, for the MUSIM purpose, a network or a base station to deactivate or release an SCG, thereby improving network performance.

### BRIEF DESCRIPTION OF THE DRAWINGS

The above and other features of the present invention will be more apparent from the following detailed description in combination with the accompanying drawings, in which:

FIG. 1 is a schematic diagram showing a method performed by user equipment to which an embodiment of the present invention relates; and

FIG. 2 is a schematic diagram showing a simplified structure of user equipment to which the present invention relates.

### DETAILED DESCRIPTION

The following describes the present disclosure in detail with reference to the accompanying drawings and specific embodiments. It should be noted that the present disclosure should not be limited to the specific embodiments described below. In addition, for simplicity, detailed description of the prior art not directly related to the present disclosure is omitted to prevent confusion in understanding the present disclosure.

The following describes some terms involved in the present disclosure. For the specific meanings of the terms, please refer to the latest relevant 3GPP documents, for example, TS38.300, TS38.331, TS36.300, TS36.331, etc.
NAS: Non-Access Stratum.
AS: Access Stratum.
RRC: Radio Resource Control.
RRC_CONNECTED: RRC connected state.
RRC_INACTIVE: RRC inactive state.
RRC_IDLE: RRC idle state.
RAN: Radio Access Network.
USIM: Universal Subscriber Identity Module.
MUSIM: Multi-Universal Subscriber Identity Module.
Tx: transmitter.
Rx: receiver.
NR: New RAT, New Radio Access Technology.
gNB: a base station node providing NR user plane and control plane protocol terminations towards the UE, and connected, via the NG interface, to the 5G core network.
eNB: a base station node providing E-UTRAN user plane and control plane protocol terminations towards the UE, and connected to the EPC core network.
ng-eNB: a base station node providing E-UTRAN user plane and control plane protocol terminations towards the UE, and connected, via the NG interface, to the 5G core network.

Dual connectivity or multi-connectivity: meaning that UE operating in an RRC connected state establishes a physically wireless connection with more than one network node, and implements data transmission. A master node (MN) and a secondary node (SN) are included. The MN is executed by one gNB/eNB/ng-eNB. A serving cell group controlled by the MN is referred to as a master cell group (MCG). That is, the MCG is associated with the MN. At least one primary serving cell is present in the MCG, and is referred to as a primary cell (PCell). The UE performs radio link monitoring (RLM) on the PCell. If the MCG further includes other cells, then the other cells may be referred to collectively as a secondary serving cell (SCell). Correspondingly, the SN is executed by one or more gNBs/eNBs/ng-eNBs. A serving cell group controlled by the SN is referred to as a secondary cell group (SCG). That is, the SCG is associated with the SN. The SCG at least includes a primary serving cell, which is referred to as a primary second cell (PSCell). The UE performs radio link monitoring on the PSCell. If the SCG further includes other cells, then the other cells may be referred to collectively as a secondary serving cell (SCell). An SRB may be established between the SN and the UE, and is commonly referred to as SRB3. SRB3 is mainly used to transmit an RRC message between the SN and the UE, e.g., an SCG-associated measurement report.

An SCG radio bearer is present only in an SCG and has one RLC bearer, or has two RLC bearers in carrier aggregation packet duplication.

In the present disclosure, a network, a base station (or a base station node), and a RAN may be used interchangeably. The network may be a Long Term Evolution (LTE) network, an NR network, an enhanced Long Term Evolution (eLTE) network, or another network defined in a subsequent evolved version of the 3GPP.

In the present disclosure, user equipment (UE) may refer to a device that physically supports a plurality of USIM cards (two or more USIM cards). The USIM can be a physical SIM or eSIM. The device is equipped with two or more USIM cards, and each USIM card is associated with one network. The plurality of USIM cards may be from the same operator or different operators. From the perspective of the network, different USIM cards may correspond to different UEs, and each USIM card corresponds to one UE. Unless otherwise specified, the present disclosure does not distinguish therebetween. Those skilled in the art could easily determine, according to the context, whether the UE refers to UE supporting a plurality of USIM cards or UE respectively corresponding to each USIM card in a device supporting a plurality of USIM cards. User equipment configured with a plurality of USIM cards can receive and/or transmit data from and/or to a plurality of networks using single-Rx/single-Tx or dual-Rx/single-Tx by means of, e.g., time division multiplexing. UE having two Txs and two Rxs (dual-Tx/dual-Rx) can simultaneously transmit data to two networks, and can also simultaneously receive data from two networks.

The embodiments of the present disclosure use a UE configured with two USIM cards as an example, and those skilled in the art could easily expand the example to situations involving a plurality of USIM cards. In the embodiments of the present disclosure, a UE at least having dual Rx/Tx capabilities is in dual connectivity in a first network (referred to below as network A), that is, is configured with both a master cell group (MCG) and a secondary cell group (SCG) by network A. The following describes a procedure in which the UE at least having dual Rx/Tx capabilities requests, for a MUSIM purpose (the UE needs to communicate with a second network (referred to below as network B) or set up an RRC connection with the second network), network A to deactivate or release the SCG.

Embodiments in which a UE requests network A to release or deactivate an SCG for a MUSIM purpose

### Embodiment 1

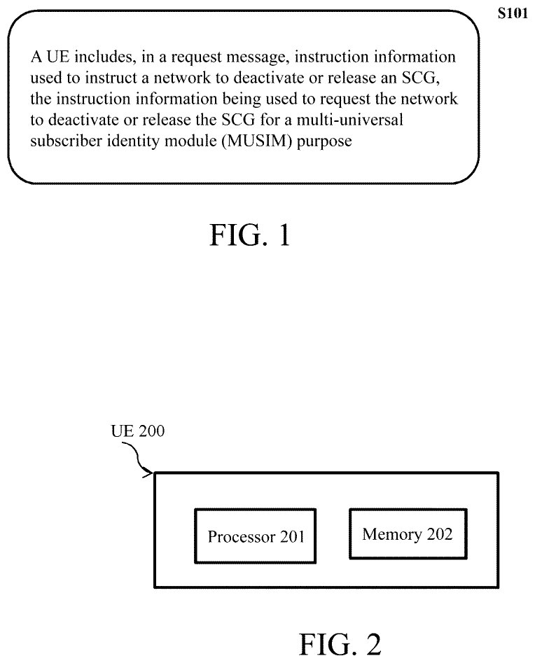

In the present embodiment, provided is a method performed when a UE at least having dual Rx/Tx capabilities is configured with both an MCG and an SCG by a network (network A). As shown in FIG. 1, the method includes the following steps:

Step S101: the UE including, in a request message, instruction information used to instruct/request the network to deactivate or release the SCG, the instruction information being used to request the network to deactivate or release the SCG for a multi-universal subscriber identity module (MUSIM) purpose, wherein the instruction information is included in a UE assistance information message.

Specifically, the UE includes, in a request message (i.e., an RRC message), instruction information used to indicate to the network that the UE requests, for a MUSIM purpose, the network to deactivate the SCG. The instruction information may be a new information element, and the new information element is used to request the network to deactivate the SCG for the MUSIM purpose. The new information element is different from the information element used by the UE in DCCA to request, for the purpose of power saving (e.g., uplink data for an SCG radio bearer is not present), deactivation of the SCG, and the new information element may be included in a UE assistance information message. The following describes an implementation means of including the new information element in the UE assistance information message.

Specifically, if the UE is configured to provide MUSIM assistance information, and further, if the UE requests, for the MUSIM purpose, the network to deactivate the SCG, then transmission of a UEAssistanceInformation message (i.e., the UE assistance information message) is initiated to provide the MUSIM assistance information.

If the UE needs to request the network to deactivate the SCG for the MUSIM purpose, the step of initiating transmission of the UEAssistanceInformation message to provide the MUSIM assistance information includes the following operations: if the UE prefers (i.e., needs) to deactivate the SCG, then including an information element deactivateScgRequest (referred to as a first SCG deactivation request indicator) in the UEAssistanceInformation message; otherwise (the UE does not prefer to deactivate the SCG), not including the information element deactivateScgRequest in the UEAssistanceInformation message (this is an optional operation). The information element deactivateScgRequest is used to indicate to the network that the UE needs to deactivate the SCG for the MUSIM purpose. It should be noted that the purpose of determining whether the UE needs to deactivate the SCG for the MUSIM purpose may be achieved by whether the information element deactivateScgRequest is included in the UEAssistanceInformation message, and the purpose may also be achieved by setting the value of the information element deactivateScgRequest. In other words, when the UE needs to request the network to deactivate the SCG for the MUSIM purpose, the value of deactivateScgRequest is set to a value predefined for achieving said purpose, and for example, is set to deactviated.

If the UE requests the network to deactivate the SCG not for the MUSIM purpose (e.g., because uplink data for an SCG radio bearer is not present), the step of initiating transmission of the UEAssistanceInformation message to provide the MUSIM assistance information includes the following operation: if the UE prefers to release the SCG, including, in the UEAssistanceInformation message, a second SCG deactivation request indicator different from the first SCG deactivation request indicator, so as to request a base station to deactivate the SCG.

Optionally, in Embodiment 1, whether the UE is permitted to request, for the MUSIM purpose, the network to deactivate the SCG is configurable. That is, only when the network configures, by means of an RRC reconfiguration message, the UE to provide a preference for deactivating the SCG for the MUSIM purpose, can the UE enable the transmission of the UEAssistanceInformation message that includes the first SCG deactivation request indicator used to request the network to release the SCG. At the time, even if the UE is configured to provide the MUSIM assistance information, if the UE is not configured to provide, for the MUSIM purpose, a preference for deactivating the SCG, the UE cannot enable the transmission of the UEAssistanceInformation message that includes the first SCG deactivation request indicator used to request the network to release the SCG.

In the present embodiment, the preference for deactivating the SCG is interchangeable with a preference for activating the SCG or a preferred SCG state. The preferred SCG state may be activating the SCG, releasing the SCG, or deactivating the SCG.

In the embodiment of the present disclosure, the procedure in which the UE requests, for the MUSIM purpose, the network to deactivate the SCG is also applicable to the UE requesting, for the MUSIM purpose, the network to release the SCG. Specifically, embodiments achieved by replacing the above deactivation of the SCG with release of the SCG can be used to achieve the objective of the UE requesting, for the MUSIM purpose, the network to release the SCG.

### Embodiment 2

A UE capable of providing MUSIM assistance information needs to request to deactivate an SCG, the following is performed:
if the UE is configured to provide the MUSIM assistance information (or is configured with musim-AssistanceConfig), if the UE needs (i.e., prefers) to deactivate the SCG, and if a timer T1 is not running (the operation of determining whether the timer T1 is running is optional), at least one of the following operations is performed:
(1) initiating, by the UE, transmission of a UEAssistanceInformation message so as to provide the MUSIM assistance information; and
(2) starting the timer T1, and setting the value of the timer to musim-DeactivateWithoutResponseTimer (the operation is optional, and is performed only when the UE is configured with musim-Deactivate WithoutResponseTimer).

It should be noted that embodiments achieved by changing the above execution order of (1) to (2) also fall within the scope of protection of the present disclosure.

When the timer T1 expires, the UE may perform operations required to be performed when deactivating the SCG.

The operations performed during the SCG deactivation procedure include at least one of the following:
1 Considering the SCG as deactivated.
2. Indicating to a lower layer (e.g., a Medium Access Control (MAC) layer) that the SCG is deactivated.
3. If the UE is in an RRC connected state and if the SCG was active therebefore (e.g., the SCG was active before the expiration of the timer T1, or the SCG was active before receiving a message for enabling the present SCG deactivation procedure, or the SCG was active before enabling the present SCG deactivation procedure), and if the UE is configured with SRB3, then triggering a PDCP entity of SRB3 to perform an SDU discarding operation, and re-establishing an RLC entity of SRB3.

### Embodiment 3

A UE capable of providing MUSIM assistance information needs to request to release an SCG, the following is performed:

If the UE is configured to provide the MUSIM assistance information (or is configured with musim-AssistanceConfig), if the UE needs (i.e., prefers) to release the SCG, and if a timer T2 is not running (the operation of determining whether the timer T2 is running is optional), then at least one of the following operations is performed:
(1) initiating, by the UE, transmission of a UEAssistanceInformation message so as to provide the MUSIM assistance information; and
(2) starting the timer T2, and setting the value of the timer to musim-ReleaseWithoutResponseTimer (the operation is optional, and is performed only when the UE is configured with musim-ReleaseWithoutResponseTimer).

It should be noted that embodiments achieved by changing the above execution order of (1) to (2) also fall within the scope of protection of the present disclosure.

When the timer T2 expires, the UE may perform operations required to be performed when releasing the SCG.

The operations performed in the SCG release procedure include at least one of the following:
1. Resetting SCG MAC (the operation is performed only if said configuration is present).
2. For each RLC bearer in an SCG configuration, performing an RLC bearer release procedure.
3. Releasing the SCG configuration.
4. If a conditional PSCell change (CPC) is configured, deleting all items (if present) in VarConditionalReconfig. The UE variable VarConditionalReconfig includes an accumulatively configured conditional handover or conditional PSCell change, and includes a pointer pointing to a conditional handover or conditional PSCell change execution condition, and a stored target candidate SpCell RRC reconfiguration.
5. If a timer T310 is running, stopping the timer T310 corresponding to a special cell SpCell (i.e., PCell or PSCell).
6. If a timer T312 is running, stopping the timer T312 corresponding to the SpCell.
7. If a timer T304 is running, stopping the timer T304 corresponding to the SpCell.

It should be noted that the timers T1 and T2 may be the same timer. For conditions of starting and stopping the timers T310, T312, and T304, please refer to the latest 3GPP technical specifications TS38.331.

In dual connectivity carrier aggregation (DCCA), a gNB (network A) may activate an SCG in a deactivated state at any time when required (e.g., arrival of downlink data). However, in MUSIM, after the SCG is deactivated for the MUSIM purpose, network A does not know whether the UE is communicating with network B, and thus even if downlink data for an SCG radio bearer for the UE arrives, the network A cannot activate the SCG. Embodiment 4 provides a mechanism to solve said problem. That is, the UE, after finishing communication with network B, transmits instruction information to network A, and network A may activate the SCG as required upon receiving the instruction information.

### Embodiment 4

A UE capable of providing MUSIM assistance information needs to request to activate an SCG, the following is performed:

If the UE is configured to provide the MUSIM assistance information (or is configured with musim-AssistanceConfig), and if the SCG state preferred by the UE changes, the following operation is performed:
(1) initiating, by the UE, transmission of a UEAssistanceInformation message so as to provide the MUSIM assistance information.

In Embodiment 4, the changing of the SCG state preferred by the UE may be replaced with the UE preferring to activate the SCG or the UE releasing an RRC connection with another network.

Currently, in DCCA, when uplink data arrives at the UE, the UE may request a base station to activate the SCG or indicate to the base station that uplink data for an SCG radio bearer has arrived. This is different from the case in which the UE instructs to activate the SCG in Embodiment 4.

In DCCA and MUSIM, in the following three scenarios, the UE may request to activate the SCG:
Scenario 1: Uplink data for an SCG radio bearer arrives.
Scenario 2: The UE ends communication with network B (e.g., releasing an RRC connection to network B).
Scenario 3: The UE ends communication with network B, and uplink data arrives.

Scenario 1 is applicable to the UE requesting to activate the SCG in DCCA. The UE may include, in a message transmitted to the base station, a field used to request to activate the SCG or used to indicate arrival of uplink data for the SCG radio bearer. Scenario 2 is applicable to the UE indicating to the base station in MUSUM that the capabilities of the UE are no longer limited or that the UE has completed communication with another network or that the UE has released an RRC connection with another network. Case 2 may be implemented by using the solution described in Embodiment 4. Scenario 3 is a combination of scenario 1 and scenario 2, and may therefore be implemented by combining the solution for scenario 1 and the solution for scenario 2, or by including additional information to indicate whether uplink data for the SCG radio bearer has arrived when the UE indicates to the network that the SCG state preferred thereby has changed, as shown in Embodiment 4.

Furthermore, after the UE ends communication with network B or releases an RRC connection with network B, the UE may need to end a paging message or perform measurement or other operations from network B. At the time, the UE may request a scheduling interval from network A. In other words, when the UE requests the scheduling interval from network A, information about whether the UE is communicating with network B is implicitly indicated to network A. When network A receives a message from the UE for requesting the scheduling interval, network A considers that the UE has ended the communication with network B or has released the RRC connection with network B. Therefore, if the UE needs to request the scheduling interval, the UE does not need to additionally indicate, in the UEAssistanceInformation message, information about the SCG state preferred by the UE. In such a case, if the UE is configured to provide the MUSIM assistance information (or is configured with musim-AssistanceConfig), the UE does not need to request the scheduling interval, but the SCG state preferred by the UE changes, so that the UE initiates transmission of the UEAssistanceInformation message to provide the MUSIM assistance information.

In Embodiments 1 to 4 above, if transmission of the UEAssistanceInformation message is initiated to provide the MUSIM assistance information, the UE may perform at least one of the following operations:
(1) If the UE prefers or needs to release the SCG, including musim-ReleaseScgRequest in the UEAssistanceInformation message, musim-ReleaseScgRequest being used to indicate to the base station that the UE prefers to release the SCG.
(2) If the UE prefers or needs to deactivate the SCG, including musim-DeactviateScgRequest in the UEAssistanceInformation message, musim-DeactviateScgRequest being used to indicate to the base station that the UE prefers to deactivate the SCG.
(3) If the UE prefers or needs to activate the SCG, including musim-ActivateScgRequest in the UEAssistanceInformation message, musim-ActivateScgRequest being used to indicate to the base station that the UE prefers to activate the SCG.

The above order of (1) to (3) may be changed.

In addition, an information element musim-PreferedScgStateRequest may further be set to different values (e.g., the value thereof may be one among {release, deactivate, activate}) to indicate whether the UE prefers or needs to release the SCG, deactivate the SCG, or activate the SCG. At the time, operations (1) to (3) are correspondingly as follows:
(1) if the UE prefers or needs to release the SCG, including musim-PreferedScgStateRequest in the UEAssistanceInformation message, and setting the value thereof to a value corresponding to preferring or needing to release the SCG, e.g., release;
(2) if the UE prefers or needs to deactivate the SCG, including musim-PreferedScgStateRequest in the UEAssistanceInformation message, and setting the value thereof to a value corresponding to preferring or needing to deactivate the SCG, e.g., deactivated; and
(3) if the UE prefers or needs to activate the SCG, including musim-PreferedScgStateRequest in the UEAssistanceInformation message, and setting the value thereof to a value corresponding to preferring or needing to activate the SCG, e.g., activated, wherein musim-PreferedScgStateRequest is used to indicate the SCG state preferred by the UE.

In addition, if the UE initiates transmission of the UEAssistanceInformation message due to ending communication with network B, then including additional information to indicate whether uplink data for the SCG radio bearer is present for the UE in Embodiment 4 with regard to scenario 3 may be implemented by setting the value of musim-ActivateScgRequest or musim-PreferedScgStateRequest. That is, a value is predefined for musim-ActivateScgRequest or musim-PreferedScgStateRequest to indicate that the SCG state preferred by the UE has changed and uplink data for the SCG radio bearer has arrived. For example, the value of musim-PreferedScgStateRequest is set to activatedWithData to indicate that the UE has ended communication with network B and uplink data for the SCG radio bearer has arrived. The value of musim-PreferedScgStateRequest is set to activatedWithoutData to indicate that the UE has ended communication with network B but no uplink data for the SCG radio bearer has arrived. An information element different from musim-ActivateScgRequest may also be included in the UEAssistanceInformation message to perform indication, and may be referred to as musim-ActivateScgWithDataRequest. In such a case, if the UE has ended communication with network B and uplink data for the SCG radio bearer has arrived, then musim-ActivateScgWithDataRequest is included in the UEAssistanceInformation message. If the UE has ended communication with network B but no uplink data for the SCG radio bearer has arrived, then musim-ActivateScgRequest is included in the UEAssistanceInformation message to indicate to the base station that the UE prefers to activate the SCG (or the UE has ended communication with network B or the UE has released the RRC connection with network B) but no uplink data for the SCG radio bearer has arrived. It should be noted that musim-ActivateScgWithDataRequest is different from the information element defined for arrival of uplink data for the SCG radio bearer in DCCA. musim-ActivateScgWithDataRequest is used to indicate that the UE has ended communication with network B and uplink data for the SCG radio bearer has arrived.

### Embodiment 5

In dual connectivity carrier aggregation (DCCA), when uplink data for an SCG radio bearer arrives at a UE, the UE may use an RRC message (e.g., a UEAssistanceInformation message) to request a base station to activate an SCG or indicate to the base station that uplink data for an SCG radio bearer has arrived. However, in a MUSIM scenario, if the UE is in an RRC connected state in two networks simultaneously, at this time, even if uplink data for the SCG radio bearer arrives, the UE should not initiate the UEAssistanceInformation message to request the base station to activate the SCG, or the UE should not initiate the UEAssistanceInformation message to indicate to the base station that uplink data for the SCG radio bearer has arrived so as to cause the base station to activate the SCG. In other words, when and only when the UE is not in the RRC connected state in the other network and uplink data for the SCG radio bearer arrives at the UE, can the UE request, via the RRC message (e.g., the UEAssistanceInformation message), the base station to activate the SCG or indicate to the base station that uplink data for the SCG radio bearer has arrived.

In addition, whether the UE can request the network to activate the SCG or indicate to the network that uplink data for the SCG radio bearer has arrived may also be configured by the base station by means of an RRC reconfiguration message. Correspondingly, if the UE is configured to provide a preference for activating the SCG or is configured to provide an indication of arrival of uplink data for the SCG radio bearer, when and only when the UE is not in the RRC connected state in the other network and uplink data for the SCG radio bearer has arrived at the UE, can the UE request, via the RRC message (e.g., the UEAssistanceInformation message), the base station to activate the SCG or indicate to the base station that uplink data for the SCG radio bearer has arrived.

In the embodiments of the present disclosure, the UE not being in the RRC connected state in the other network and the UE ending communication with network B are equivalent to each other, and may both be replaced with radio frequencies (or Tx/Rx) of the UE other than those for the MCG being available (or not being occupied by the other network), or UE capability limitations being removed, or UE capabilities being resumed. Correspondingly, the UE being in the RRC connected state in the other network and the UE communicating with network B are equivalent to each other, and may both be replaced with radio frequencies (or Tx/Rx) of the UE other than those for the MCG being unavailable (or being occupied by the other network) or UE capabilities being limited. The indication of arrival of uplink data for the SCG radio bearer may also be a buffer status report Medium Access Control control element (BSR MAC CE) transmitted by the UE to the MCG. The BSR MAC CE includes an indicator that may be used to indicate that the BSR MAC CE is for the SCG radio bearer.

The base station needs to know capability information of the UE when the base station configures resources for the UE. In the present disclosure, the UE requests the base station to activate the SCG, deactivate the SCG, or release the SCG for the MUSIM purpose, which may be reported to the base station as the capability information of the UE. In Embodiment 6, the UE reports, to the base station, the capability thereof for requesting, for the MUSIM purpose, the base station to activate the SCG, deactivate the SCG, or release the SCG.

### Embodiment 6

A UE receives a UE capability query message UECapabilityEnquiry from a base station. The UE configures a UE capability information message UECapabilityInformation in the following manner:
if the UE capability query message includes a UE MUSIM capability query field musim-Request (or includes a UE MUSIM SCG capability query field musim-ScgRequest):
if the UE supports activation of the SCG or deactivation of the SCG or release of the SCG for the MUSIM purpose, then MUSIM SCG-related capability information thereof is reported. Specifically, a field musim-ScgStateChange is included in musim-Parameters, and the value thereof may be set to true.

It should be noted that activation of the SCG or deactivation of the SCG or release of the SCG for the MUSIM purpose may also be reported as a separate capability. For example, if the UE supports activation of the SCG for the MUSIM purpose, a field musim-ScgActivate is included in musim-Parameters, and the value thereof may be set to true. If the UE supports deactivation of the SCG for the MUSIM purpose, a field musim-ScgDeactivate is included in musim-Parameters, and the value thereof may be set to true. If the UE supports release of the SCG for the MUSIM purpose, a field musim-ScgRelease is included in musim-Parameters, and the value thereof may be set to true.

The following describes the meaning of some messages or fields involved in the present disclosure.

The UEAssistanceInformation message is used for indicating UE assistance information to the network.

The musim-AssistanceConfig field (which may also be referred to as the musim-AssistanceConfig-Gap field) configures the UE to report the assistance information, that is, configures the UE to report the MUSIM interval preferred thereby and/or a release preference thereof for the MUSIM purpose and/or an SCG state preference thereof for the MUSIM purpose (e.g., the preference for activation of the SCG or deactivation of the SCG or release of the SCG). The base station may instruct, by means of the musim-AssistanceConfig field included in the RRC message (e.g., the RRCReconfiguration message), the UE to report the MUSIM interval preferred thereby and/or the release preference thereof for the MUSIM purpose or the SCG state preference thereof for the MUSIM purpose. In addition, the base station may also configure, by means of musim-ScgAssistanceConfig different from the musim-AssistanceConfig field, the UE to report the SCG state preference thereof for the MUSIM purpose (e.g., preference for activation of the SCG or deactivation of the SCG or release of the SCG).
musim-DeactivationScgWithoutResponseTimer indicates a time (or a timer) used by the UE to deactivate the SCG without waiting for a network response. When the timer T1 expires, the UE automatically deactivates the SCG for the MUSIM purpose.
musim-ReleaseScgWithoutResponseTimer indicates a time (or a timer) used by the UE to release the SCG without waiting for a network response. When the timer T2 expires, the UE automatically releases the SCG for the MUSIM purpose.
musim-Request is used to instruct the UE to report MUSIM-related capability information thereof.
musim-ScgRequest is used to instruct the UE to report MUSIM SCG-related capability information thereof.

FIG. 2 is a schematic diagram showing a simplified structure of user equipment (UE) according to the present invention. As shown in FIG. 2, user equipment (UE) 200 includes a processor 201 and a memory 202. The processor 201 may include, for example, a microprocessor, a microcontroller, an embedded processor, and the like. The memory 202 may include, for example, a volatile memory (such as a random access memory (RAM)), a hard disk drive (HDD), a non-volatile memory (such as a flash memory), or other memories, etc. The memory 202 has program instructions stored thereon. The instructions, when run by the processor 201, may perform the method performed by user equipment as described above in detail in the present invention.

The program running on the device according to the present invention may be a program that enables a computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The computer-executable instructions or program for implementing the functions of the embodiments of the present disclosure may be recorded on a computer-readable storage medium. The corresponding functions may be achieved by reading programs recorded on the recording medium and executing the programs by a computer system. The phrase “computer system” herein may be a computer system embedded in the device, which may include operating systems or hardware (e.g., peripherals). The “computer-readable storage medium” may be a semiconductor recording medium, an optical recording medium, a magnetic recording medium, a short-time dynamic memory program recording medium, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1-10. (canceled)

11. A User Equipment (UE), comprising:
one or more processors; and
at least one memory, wherein the at least one memory stores instructions that, when executed by the one or more processors, cause the one or more processors to:
in response to determining that the UE is configured to provide Multi-Universal Subscriber Identity Module (MUSIM) assistance information, that the UE has a preference to release a Secondary Cell Group (SCG) and that a timer is not running,
initiate transmission of the UE assistance information message; and
start the timer, wherein
a musim-ReleaseScgRequest is included in the message to indicate the UE's preference on the SCG to be released for the MUSIM.

12. The UE according to claim 11, wherein
the at least one memory stores further instructions that, when executed by the one or more processors, cause the one or more processors to:
in response to determining that the timer expires, consider that the SCG is released.

13. A control method in a User Equipment (UE), comprising:
in response to determining that the UE is configured to provide Multi-Universal Subscriber Identity Module (MUSIM) assistance information, that the UE has a preference to release a Secondary Cell Group (SCG) and that a timer is not running,
initiating transmission of the UE assistance information message; and
starting the timer, wherein
a musim-ReleaseScgRequest is included in the message to indicate the UE's preference on the SCG to be released for the MUSIM.
